(19) United States
(12) Patent Application Publication
(10) Pub. No.: US 2015/0066970 A1
(43) Pub. Date: Mar. 5, 2015

(54) METHODS AND SYSTEMS FOR GENERATING CONCIERGE SERVICES RELATED TO MEDIA CONTENT

(71) Applicant: United Video Properties, Inc., Santa Clara, CA (US)

(72) Inventors: Leonard T. Guzman, San Jose, CA (US); Barbara F. Skliba, Mountain View, CA (US)

(73) Assignee: United Video Properties, Inc., Santa Clara, CA (US)

(21) Appl. No.: 14/015,865

(22) Filed: Aug. 30, 2013

(51) Int. Cl. G06F 17/30

(52) U.S. Cl. CPC G06F 17/30595
USPC 707/758

(57) ABSTRACT

Methods and systems are disclosed herein for a media guidance application that integrates available media content and user selections of that media content with social and/or physical activities. Specifically, a media guidance application is disclosed herein for recommending activities associated with a selected media asset. In addition, the media guidance application may schedule an itinerary that includes the recommended activities as well as present media assets for consumption during each activity in the itinerary.

### BACKGROUND

Media content delivery systems such as cable, satellite, and Internet systems provide users with a plethora of available media content. However, due to health and lifestyle choices people are increasingly attempting to “get off the couch” and participate in social and/or physical activities. Nonetheless, people still enjoy consuming media content, and the particular media content a person consumes is generally a good indicator of the social and/or physical activities that would interest a user.

### SUMMARY

Accordingly, methods and systems are disclosed herein for a media guidance application that integrates available media content and user selections of that media content with social and/or physical activities. Specifically, a media guidance application is disclosed herein for recommending activities associated with a selected media asset. In addition, the media guidance application may schedule an itinerary that includes the recommended activities as well as present media assets for consumption during each activity in the itinerary.

In some aspects, a media guidance application may recommend one or more social and/or physical activities in which a user may participate based on the social and/or physical activities corresponding to a media listing currently selected by a user. In some embodiments, the activity may occur at a different location than the user's current location. Accordingly, in addition to recommending activities that correspond to a currently selected media asset, the media guidance application may filter available activities based on a location of the user. For example, in recommending activities, the media guidance application may consider a distance from the user of each activity and whether or not time constraints and/or travel options limit a user's ability to attend the activity.

In some aspects, the media guidance application may recommend an itinerary that includes an initial activity associated with a selected media asset as well as other activities associated with the initial activity. For example, for a particular time window (e.g., a length of time available to a user to perform one or more activities and/or a start time and an end time available to the user), the media guidance application may populate an itinerary with multiple activities. The media guidance application may associate each of the multiple activities with a length of time, and the sum of the length of times associated with the multiple activities may correspond to the length of the time window.

In some aspects, the media guidance application may generate a display of an adjustable itinerary including the first activity and the second activity with options to modify the first or second activity. For example, after reviewing an initial itinerary, the user may wish to modify one or more activities. In response to receiving a user input to change an activity, the media guidance application may determine whether or not a third activity corresponds to the first and/or second criteria and include the third activity in the itinerary.

In some aspects, the media guidance application may also select a first media asset associated with the first activity for presentation during the first activity and select a second media asset associated with the second activity for presentation during the second activity. For example, if an itinerary includes traveling via car to a baseball game, the media guidance application may present promotions for the game during the time the user is in the car and present play-by-play commentary while a user is at the baseball game.

In some aspects, the media guidance application may receive a user selection of a media guidance datum and cross-reference the selected media guidance datum with a database associated with activities associated with media guidance data to retrieve a first activity associated with the selected media guidance data. The media guidance application may then retrieve first criteria that indicate a location of a user and a window of availability of the user and determine whether the first activity corresponds to the first criteria (e.g., whether or not the first activity may be complete within the window of availability of the user and whether or not the first activity is within an appropriate distance from the user).

In response to determining the first activity corresponds to the first criteria, the media guidance application selects the first activity and identifies a second activity associated with the first activity. The media guidance application retrieves second criteria that indicate a location associated with the first activity and an amount of the window of availability not consumed by the first activity. The media guidance application determines whether the second activity corresponds to the second criteria, and in response to determining the second activity corresponds to the second criteria, the media guidance application generates a display of the first activity and the second activity to the user.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance application for recommending activities associated with media assets in accordance with some embodiments of the disclosure;

FIG. 2A shows an illustrative media guidance application for generating a display of activities associated with media assets in accordance with some embodiments of the disclosure;

FIG. 2B shows another illustrative media guidance application for generating an itinerary of activities associated with media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flow-chart of illustrative steps involved in determining activities associated with media assets in accordance with some embodiments of the disclosure;

FIG. 6 is a flow-chart of illustrative steps involved in generating an itinerary of activities associated with media assets in accordance with some embodiments of the disclosure; and

FIG. 7 is a flow-chart of illustrative steps involved in associating a media asset with an activity in accordance with some embodiments of the disclosure.

### DETAILED DESCRIPTION OF THE DRAWINGS

Methods and systems are disclosed herein for a media guidance application that integrates available media content and user selections of that media content with social and/or physical activities. Specifically, a media guidance application is disclosed herein for recommending activities associated with a selected media asset. In addition, the media guidance application may schedule an itinerary that includes the recommended activities as well as present media assets for consumption during each activity in the itinerary.

As referred to herein an “interactive media guidance application” or, sometimes, a “media guidance application” or a “guidance application” refers to an application that provides media guidance through an interface that allows users to efficiently navigate, identify, and select media assets and/or media guidance data.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As referred to herein, an “activity” refers to a specified pursuit in which a user partakes that requires movement of the body. For example, the activity may be a physical activity, which is an activity that requires bodily movement produced by skeletal muscles that requires energy expenditure. The activity may also be a social activity, which is an activity that involves more than a single person. In some embodiments the activity may accompany the consumption of a media asset. For example, activities such as attending a movie, eating dinner, riding in a taxi, driving a car, etc. may all be accompanied by the presentation of a media asset (e.g., a movie, a song, a game, etc.).

In some embodiments, a media guidance application may recommend one or more activities in which a user may participate based on whether or not the activities correspond to a media listing currently selected by a user. In some embodiments, the activity may occur at a different location than the user's current location. Accordingly, in addition to recommending activities that correspond to a currently selected media asset, the media guidance application may filter available activities based on a location of the user. For example, in recommending activities, the media guidance application may consider a distance from the user of each activity and whether or not time constraints (e.g., the amount of time a user will require to travel the distance, the amount of time the user has available for an activity, etc.) and/or whether or not a user's travel options (e.g., the method of travel, the cost of available methods of travel, etc.) limit a user's ability to attend the activity.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

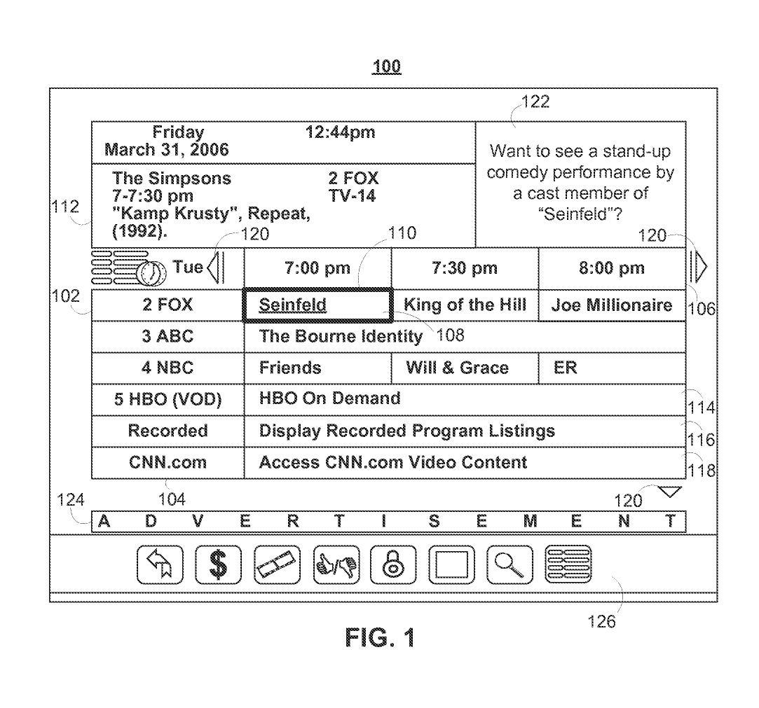

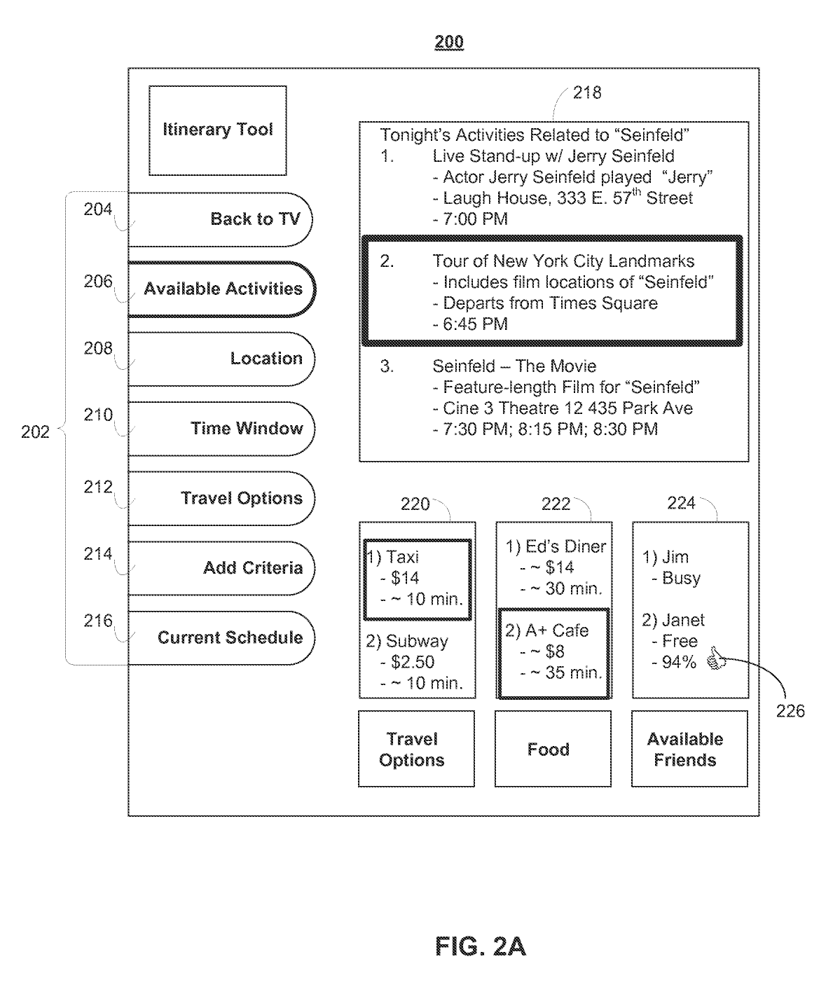

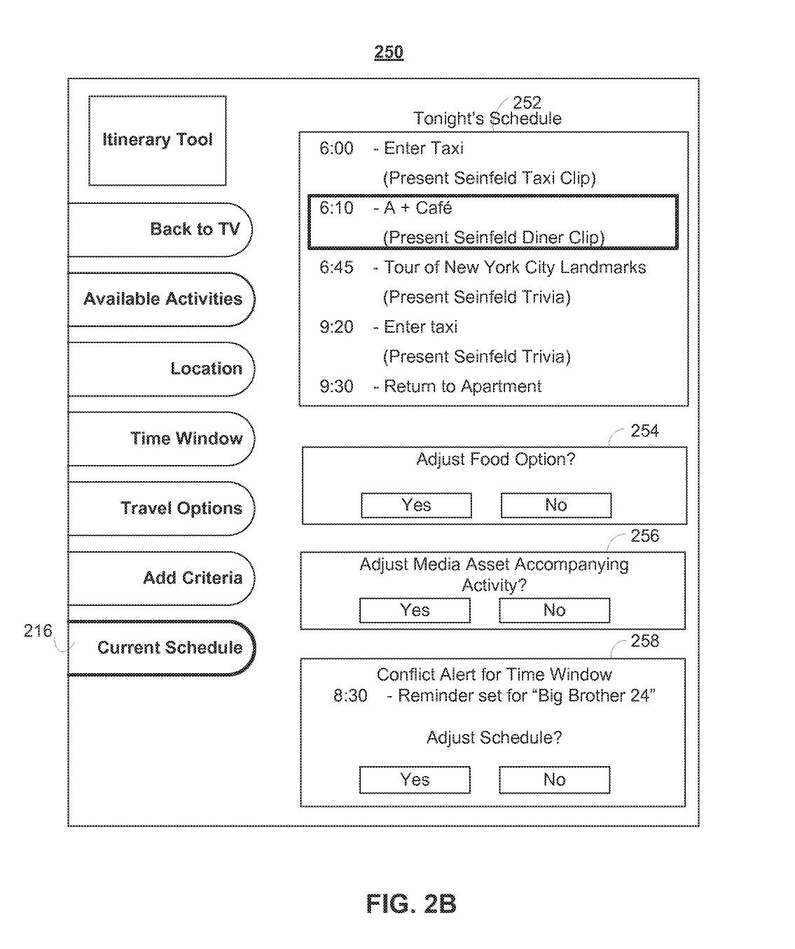

FIGS. 1 and 2A-B show illustrative display screens that may be used to provide media guidance data. The display screens shown in FIGS. 1 and 2A-B may be implemented on any suitable user equipment device or platform. While the displays of FIGS. 1 and 2A-B are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 currently presents an activity recommendation. For example, in response to a user's selection of program listing 108, the media guidance application has generated a recommendation of an activity (e.g., a stand-up comedy performance featuring a cast member of “Seinfeld”) associated with program listing 108. In some embodiments, in response to a user selection, the media guidance application may redirect a user to a display for selecting an activity (e.g., display 200 (FIG. 2A)) or a display for planning an itinerary (e.g., itinerary 252 (FIG. 2B)).

Although in FIG. 1 the media guidance application generated a recommendation in video region 122 in response to a user selection of program listing 108, in some embodiments, the media guidance application may generate recommendations based on other factors. For example, the media guidance application may generate a recommendation for an activity (e.g., ordering food, attending a restaurant, finishing homework, posting a review, etc.) in response to determining that a particular media asset that a user is likely to consume (e.g., as indicated by past viewing history) is scheduled to be or has been presented.

In some embodiments, an itinerary of a user (e.g., a number of activities to be performed by a user during a given time period) may include a period in which a user may consume one or more media assets. The media guidance application may adjust the recommendations (e.g., as displayed in video region 122) accordingly. For example, in response to determining that a user wishes to view a broadcasted television program at 7:00 PM., the media guidance application may remind a user periodically before 7:00 PM to start his/her homework. Additionally or alternatively, after the conclusion of the media asset, the media guidance application may remind a user to resume his/her homework.

In some embodiments, video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, I I I et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

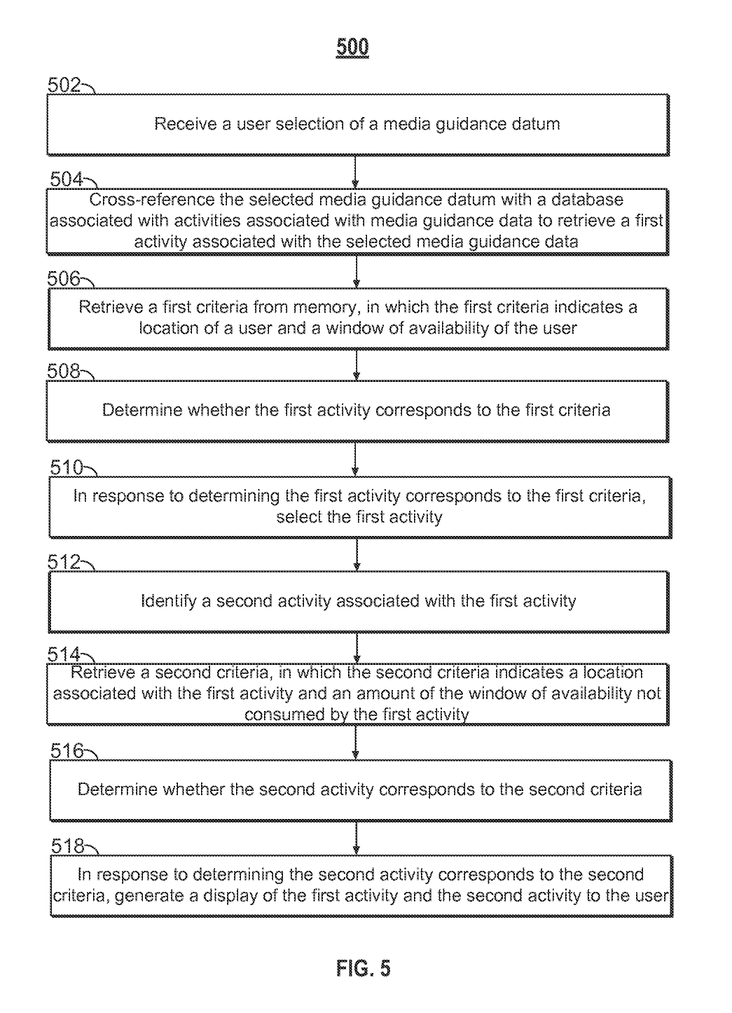

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2A. FIG. 2A shows an illustrative media guidance application for generating a display of activities associated with media assets. Video mosaic display 200 includes selectable options 202 for use in customizing activity recommendations. In response to receiving user selections related to selectable options 202, the media guidance application may recommend activities based on particular criteria of a user. In some embodiments, selectable options 202 may include default settings for one or more values associated with each of selectable options 202 and/or may automatically retrieve one or more values associated with each of selectable options 202 based on a user profile (e.g., indicative of preferences of the user).

In some embodiments, the media guidance application may generate display 200 in response to a user selecting video region 122 (FIG. 1), while an activity recommendation is displayed. For example, selection of selectable options 204 may return a user to display 100 FIG. 1)). Alternatively or additionally, the media guidance application may generate display 200 in response to a user request to receive an activity recommendation. Alternatively or additionally, the media guidance application may generate display 200 in response to detecting an activity associated with currently highlighted and/or selected media guidance data (e.g., a program listing).

Display 200 shows multiple ways in which activity recommendation 218 may be customized based on a user. For example, selectable option 206 is currently selected. In response, the media guidance application has generated activity recommendation 218. Activity recommendation 218 includes numerous activities, each associated with selected media guidance data (e.g., program listing 108 (FIG. 1)). Furthermore, activity recommendation 218 includes additional information such as how the activity is related to a current user selection, the location of the activity, the time of the activity, and/or any other information that may be useful and/or requested by a user. As indicated in FIG. 2A, one of the activities is currently selected by a user (e.g., as indicated by the dark border).

Display 200 also includes selectable option 208. Selectable option 208 allows a user to input a particular location of the user or of potential activities. Alternatively or additionally, the media guidance application may retrieve location information for the user or activities based on a global positioning system (“GPS”). The media guidance application may also receive a threshold area (e.g., a particular geographic radius from the user that the user is able to travel within and/or a geographic radius from the user within which activities must be located.

Display 200 also includes selectable option 210. Selectable option 210 allows a user to input a particular time window available for the performance of one or more activities. For example, a time window may indicate a length of time and/or a start time and an end time that a user has available for one or more activities. The time window may be continuous or include one or more breaks. In some embodiments, the time window may include one or more conflicts or unavailable times. For example, a user may have a prior engagement that is overlapped by the time window. For example, the media guidance application may determine that a user wishes to be home to watch a televised football game at a particular time. Therefore, the media guidance application may select only activities that allow for the user to return home in time for the beginning of the game. Additionally or alternatively, the media guidance application may generate a prompt to the user related to the conflict.

In some embodiments, the media guidance application may generate a display of previously scheduled events and/or potential conflicts in response to a user selecting selectable option 216. For example, in response to selecting selectable option 216, the media guidance application may generate a calendar/day planner function that shows currently scheduled events of a user. In some embodiments, a current schedule of the user may be synched to one or more devices. For example, in order to populate the current schedule of the user, the media guidance application may contact one or more remote devices and query the remote devices for any scheduling information of the user.

Display 200 also includes selectable option 212. Selectable option 212 allows a user to input available travel options. For example, the media guidance application may receive an indication of the modes of travel available to the user (e.g., whether or not a user owns a car, the distance a user is capable of walking, whether or not a user wishes to ride a subway, etc.). The media guidance application may also receive an indication of the rate of travel (e.g., how fast a user walks, how fast a user drives, etc.). Additionally or alternatively, the media guidance application may determine the availability of travel options and/or any information (e.g., a rate of travel) associated with each travel option based on prior trips of a user. The media guidance application may also receive information about travel options from third parties (e.g., retrieve public bus schedules, industry reports of typical travel times, traffic/weather conditions, etc.) any of which may affect the travel options and/or activities recommended to a user.

In some embodiments, travel options may also change based on other factors. For example, travel options may change based on days of the week, costs, any/or other users that may also be using the travel option (e.g., carpools). For example, the media guidance application may determine that a user does not own a car, and therefore a car is typically not listed as a travel option. However, in response to determining that a friend of a user is available (e.g., based on field 224) and the friend is associated with a car, the media guidance application may include a car as a travel option of the user.

Display 200 also includes selectable option 214. Selectable option 214 allows a user to input any additional criteria. In some embodiments, a media guidance application may include multiple instances of selectable option 214. For example, the media guidance application may further filter available activities based on any criteria known to the user. For example, a user may request the media guidance application suggest restaurants. In response, the media guidance application may generate a list (e.g., as shown in field 222) of restaurants.

Display 200 may also include multiple fields. For example, a field may display various activities (e.g., activity recommendation 218), a field may display various travel options (e.g., field 220), a field may display various food options (e.g., field 222), a field may display available friends (e.g., as linked via a social network) that may wish to participate with a user in various activities (e.g., field 224). It should be noted that the media guidance application may generate numerous fields. The fields may correspond to any criteria determined by the media guidance application and/or by a user. Furthermore, one field may be dependent on another field.

For example, in response to a user selection of an activity in a first field (e.g., activity recommendation 218), the media guidance application may populate a second field (e.g., field 220) with travel options for getting to the activity. Likewise, the media guidance application may populate a third field (e.g., field 222) with food options associated with the activity. The food options presented in the third field may also correspond to an amount (e.g., a number of minutes, a length/unit of time, etc.) of a time window remaining after a user partakes in the activity selected in the first field and an activity selected in a second field (e.g., riding in a taxi). Furthermore, a fourth field (e.g., field 224) may list one or more friends interested in one or more of the selected activities from the different fields.

In another example, in response to a user selection of a friend in the fourth field (e.g., field 224 (FIG. 2A)), the media guidance application may populate a first field (e.g., activities recommendation 218) with activities the friend would be interested in. The media guidance application may also generate graphical icons (e.g., icon 226), which graphically represent information to the user. For example, icons may indicate whether or not a user enjoys or “likes” one or more activities. Icons may indicate whether or not a particular restaurant is highly rated. Icons may indicate whether a particular travel option has reduced availability (e.g., in response to real-time traffic reports), and/or icons may represent any other information of interest to a user.

It should be noted, in display 200 the fields may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing.

The fields in display 200 are of different sizes (i.e., activities recommendation 218 is larger than fields 220, 222, and 224), but if desired, all the fields may be the same size. Fields may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

FIG. 2B shows another illustrative media guidance application for generating an itinerary of activities associated with media assets. FIG. 2B shows display 250. Display 250 includes itinerary 252 and options 254, 256, and 258. In some embodiments, itinerary 252 and options 254, 256, and 258 may be generated by the media guidance application in response to a user selection of selectable option 216. For example, using activities recommendation 218, and fields 220, 222, and 224, the media guidance application may generate an itinerary of activities associated with a user selection of media guidance data (e.g., program listing 108 (FIG. 1)).

One or more of the activities in itinerary 252 may be associated with the user selection of media guidance data (e.g., program listing 108 (FIG. 1)). For example, in response to a user selection of a television show, the media guidance application may recommend attending a live performance of the show, recommend eating dinner at a restaurant used in the filming of the show, and/or using a mode of transportation frequently shown in the show. Additionally or alternatively, recommended activities in itinerary 252 may be recommended based on their association to other activities in itinerary 252. For example, the media guidance application may recommend a restaurant because it is near an activity selected by a user. In another example, a restaurant may be selected because it compliments a previously selected activity (e.g., a wine tasting outing may be accompanied by a dinner at an Italian restaurant featuring a wide selection of wines).

In some embodiments, the media guidance application may also suggest media assets to accompany each activity. For example, the media guidance application may select promotional material (e.g., advertisements, background information, etc.) to be displayed to the user before an activity, supplemental information (e.g., play-by-play announcements, added features, subtitles, etc.) during the activity, and re-cap information (e.g., critical reviews, discussion boards, etc.) after the activity.

In some embodiments, the media guidance application may be implemented on or have access to multiple devices. For example, the media guidance application may present media assets on one user device (e.g., a television) during part of the itinerary and present media assets on another user device (e.g., a smartphone) during a different part of the itinerary. In some embodiments, the media guidance application may determine (e.g., via a user input, proximity of a user to one of a plurality of user devices, etc.) a particular user device to use to present one or more media assets of the itinerary.

In some embodiments, the media guidance application may track the progress of the user through the itinerary. For example, an interval clock mechanism may compare a current time to a corresponding time in the itinerary, and present a media asset and/or update the itinerary based on the current time of the user. The media guidance application may also use GPS tracking to determine whether or not a user is at the location of a scheduled activity at the correct time. If the user is not at the correct location, the media guidance application may adjust the itinerary. For example, the media guidance application may determine if a user is ahead of or behind schedule in the itinerary. In response to determining that the user's progress deviates from the itinerary, the media guidance application may update the itinerary.

In some embodiments, the media guidance application may implement a checkpoint system whereby the user “checks into” each activity. Upon “checking in” or “checking out,” the media guidance application updates the itinerary. For example, upon arriving at a first activity in the itinerary, the media guidance application may receive a user input indicating that the user has arrived. In response, the media guidance application may update a user's progress in the itinerary and/or begin presentation of a media asset associated with the first activity.

Display 250 may also include options for adjusting itinerary 252. For example, the media guidance application may generate an interface for receiving user inputs related to itinerary 252. Option 254 allows a user to adjust a food option selected in itinerary 252. Option 256 allows a user to adjust a media asset accompanying an activity selected in itinerary 252, and option 258 alerts a user to a conflict occurring based on itinerary 252. It should be noted that the features discussed in relation to FIGS. 1 and 2A-B are illustrative only, and displays with more or fewer features are fully contemplated by this disclosure.

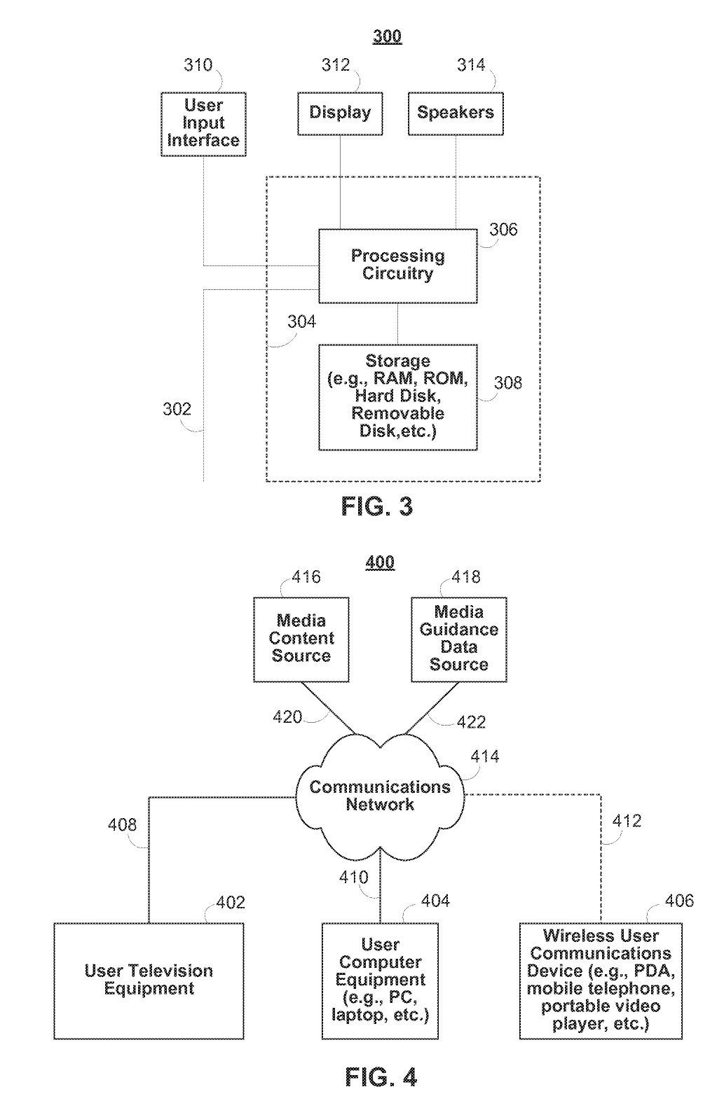

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

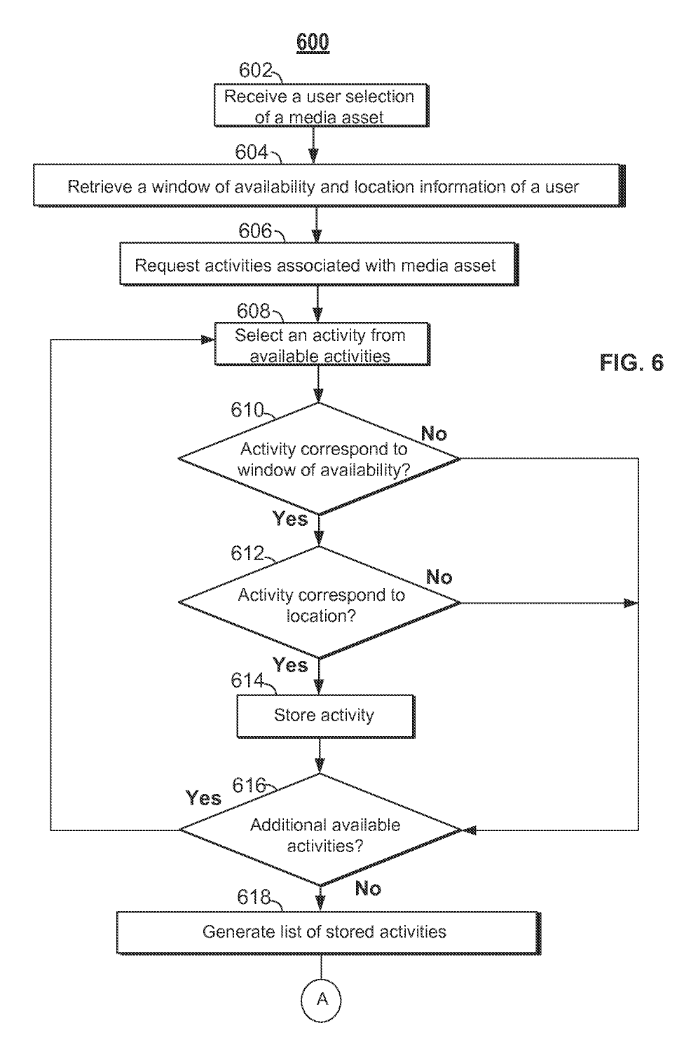

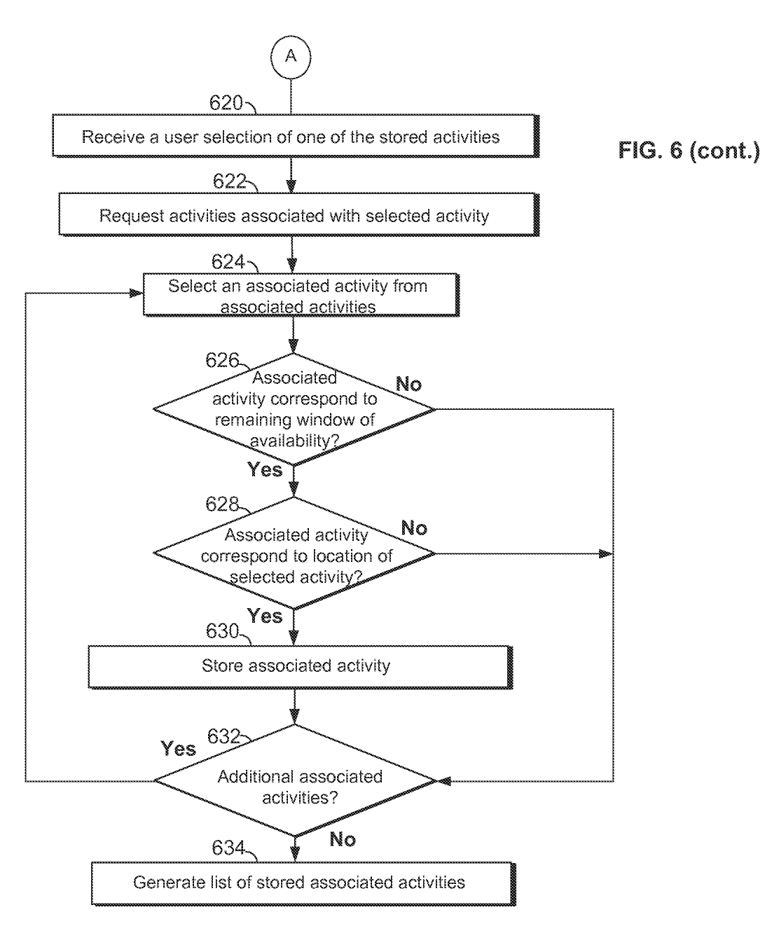

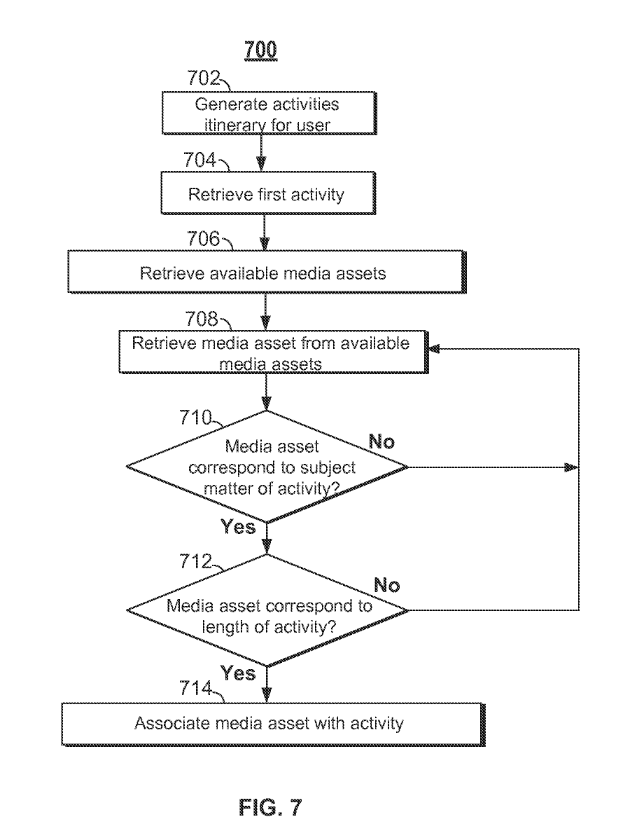

FIG. 5 is a flow-chart of illustrative steps involved in determining activities associated with media assets. It should be noted that process 500 or any step thereof could be performed on, or provided by, any of the devices shown in FIGS. 3-4. For example, process 500 may be executed by control circuitry 304 (FIG. 3) as instructed by a media guidance application implemented on user equipment 402, 404, and/or 406 (FIG. 4) in order to produce a display (e.g., display 200 (FIG. 2A)) of activities associated with media guidance data (e.g., selected by a user via user input interface 310 (FIG. 3)). In addition, one or more steps of process 500 may be incorporated into or combined with one or more steps of any other process as described in FIGS. 6 and 7.

At step 502, the media guidance application receives a user selection of a media guidance datum. For example, a user (e.g., via user input interface 310 (FIG. 3)) may enter one or more inputs, which are received by the media guidance application. In response to one or more of the inputs, the media guidance application (e.g., via control circuitry 304 (FIG. 3)) may generate a display of (or alter a display of) a display (e.g., display 100 (FIG. 1)) on a display screen (e.g., display 312 (FIG. 3)) of a user device (e.g., user equipment device 402, 404, and/or 406 (FIG. 4)).

The one or more user inputs may select a program listing (e.g., program listing 108 (FIG. 1)) or the one or more user inputs may highlight (e.g., as shown by highlight region 110 (FIG. 1)) a media listing. In response to the one or more user inputs, the media guidance application (e.g., via processing circuitry 306 (FIG. 3)) may determine (e.g., via processing circuitry 306 (FIG. 3)) media guidance data associated with the one or more user inputs. For example, in response to a user selection of a media listing, the media guidance application may receive media guidance data about the media listing. In another example, in response to a user selection of a category, the media guidance application may receive media guidance data about the category.

At step 504, the media guidance application cross-references the selected media guidance datum with a database associated with activities associated with media guidance data to retrieve a first activity associated with the selected media guidance data. For example, the media guidance application may input (e.g., using control circuitry 304 (FIG. 3)) the received media guidance data into a database (e.g., storage 308 (FIG. 3) or a storage device accessible via communications network 414 (FIG. 4)). The database (e.g., structured as a look-up table) may identify (e.g., in response to instructions issued by the media guidance application) all media guidance data in the database matching the inputted media guidance data.

In response to identifying media guidance data that corresponds to the inputted media guidance data, the database (e.g., in response to instructions issued by the media guidance application) determines one or more activities associated with the inputted media guidance data. For example, for each media guidance datum, the database may include one or more fields that describe one or more activities associated with the media guidance datum. The database may then output the one or more activities retrieved from the one or more fields associated with the inputted media guidance datum.

At step 506, the media guidance application retrieves first criteria from memory that indicates a location of a user and a window of availability of a user. For example, the media guidance application may retrieve (e.g., via control circuitry 304 (FIG. 3)) information about a user (e.g., stored in a user profile at storage 308 (FIG. 3) and/or a storage device accessible from communications network 414 (FIG. 4)). The information about the user may indicate the current location of the user and a time window of availability of the user. Additionally or alternatively, the media guidance application may receive (e.g., via control circuitry 304 (FIG. 3)) a user input (e.g., entered into user input interface 310 (FIG. 3)) selecting particular options (e.g., selectable options 202 (FIG. 2A)), which indicate the current location of the user, a window of availability of the user, and any other criteria that may affect the activities a user would like recommended.

In some embodiments, the media guidance application may retrieve (e.g., via I/O path 302 (FIG. 3)) information related to the GPS coordinates of a user. For example, the media guidance application may be implemented on, of have access to a user device (e.g., user drive 300 (FIG. 3)), which includes a global positioning module. Based on information from the module, the media guidance application (e.g., via processing circuitry 306 (FIG. 3)) may determine a location of a user. In some embodiments, the media guidance application may retrieve (e.g., via I/O path 302 (FIG. 3)) scheduling information (e.g., from a calendar application incorporated into or accessible by the media guidance application) associated with the user. Based on the scheduling information, the media guidance application may determine the time availability of the user.

At step 508, the media guidance application determines whether or not the first activity corresponds to the first criteria. For example, the media guidance application may retrieve one or more activities (e.g., from storage 308 (FIG. 3)) that correspond to media guidance data associated with one or more user inputs. The media guidance application may filter (e.g., via processing circuitry 306 (FIG. 3)) the more or more activities based on whether or not the one or more actives correspond to the location and time window of the user. For example, although an activity (e.g., attending a baseball game) may correspond to media guidance data associated with one or more user inputs (e.g., a user selection of television broadcast of the baseball game), the media guidance application may determine that the location or time available to the user (either to travel to the game or to simply attend the game) does not correspond to the location and/or time requirement of the activity.

In some embodiments, a database (e.g., storage 308 (FIG. 3) or a storage device accessible via communications network 414 (FIG. 4)) may include additional data about each activity in the database. For example, the database may indicate the location of the activity and the time necessary to attend/perform the activity. The database may also include (or the media guidance application may determine (e.g., via processing circuitry 306 (FIG. 3)) the time necessary for the user, based on travel options of the user, to travel to the location. The media guidance application may compare the location and time information associated with the activity to the location and time availability of the user.

If the media guidance application (e.g., via processing circuitry 306 (FIG. 3)) determines that the location exceeds a threshold distance from the user or that the time requirements of the activity exceeds the time availability of the user, the media guidance application may determine that the activity does not correspond to the first criteria. In contrast, if the media guidance application (e.g., via processing circuitry 306 (FIG. 3)) determines that the location does not exceed a threshold distance from the user or that the time requirements of the activity does not exceed the time availability of the user, the media guidance application may determine that the activity does correspond to the first criteria.

At step 510, in response to determining that the first activity corresponds to the first criteria, the media guidance application selects the activity. For example, in response to determining (e.g., via processing circuitry 306 (FIG. 3)) that a user may travel to the location of the activity within his/her window of availability, the media guidance application may determine that the activity corresponds to the media guidance data associated with the one or more user inputs received (e.g., via user input interface 310 (FIG. 3)) from a user.

At step 512, the media guidance application identifies a second activity associated with the first activity. For example, the media guidance application may input (e.g., using control circuitry 304 (FIG. 3)) the first activity into a database (e.g., storage 308 (FIG. 3) or a storage device accessible via communications network 414 (FIG. 4)). The database (e.g., structured as a look-up table) may identify (e.g., in response to instructions issued by the media guidance application) all activities in the database corresponding to (e.g., typically performed adjacent to) the inputted activity. In response to identifying activities that corresponds to the inputted activity, the database (e.g., in response to instructions issued by the media guidance application) determines one or more activities associated with the inputted activity. For example, for every activity associated with media guidance data, the database may include one or more fields that describe one or more other activities associated with the inputted activity. The database may then output the one or more activities retrieved from the one or more fields associated with the inputted activity.

At step 514, the media guidance application retrieves second criteria that indicate a location associated with the first activity and an amount of time of the window of availability of the user not consumed by the first activity. For example, the media guidance application may retrieve information (e.g., via control circuitry 304 (FIG. 3)) about the first activity (e.g., storage 308 (FIG. 3) and/or a storage device accessible from communications network 414 (FIG. 4)). The information about the first activity may indicate the location of the activity and an amount of time associated with the first activity.

Additionally or alternatively, the media guidance application may receive (e.g., via control circuitry 304 (FIG. 3)) a user input (e.g., entered into user input interface 310 (FIG. 3)) selecting particular options (e.g., selectable options 202 (FIG. 2A)), which indicate the other criteria that may affect the activities a user would like recommended (e.g., a user may enter the genre of restaurant that that he/she wants). In some embodiments, the media guidance application may retrieve (e.g., via I/O path 302 (FIG. 3)) information related to the GPS coordinates of the first activity and or GPS coordinates of the user. In some embodiments, the media guidance application may compare the GPS coordinates of the user to determine (e.g., via processing circuitry 306 (FIG. 3)) whether or not a user is ahead or behind schedule in an itinerary generated by the media guidance application. Based on whether or not the user is on schedule, the media guidance application may adjust the second criteria.

At step 516, the media guidance application determines whether or not the second activity corresponds to the second criteria. For example, the media guidance application may retrieve one or more activities (e.g., from storage 308 (FIG. 3)) that correspond to the first activity. The media guidance application may filter (e.g., via processing circuitry 306 (FIG. 3)) the more or more activities based on whether or not the one or more actives correspond to the location of the first activity and the amount of the time window of the user remaining after performing the first activity. For example, although an activity (e.g., eating dinner at a restaurant) may correspond to a first activity (e.g., viewing a movie at a theatre), the media guidance application may determine that the location or time available to the user (either to travel to/from the restaurant from/to the theatre or to simply view the movie) does not correspond to the location of the activity and/or remaining time availability of the user before/after the first activity.

In some embodiments, a database (e.g., storage 308 (FIG. 3) or a storage device accessible via communications network 414 (FIG. 4)) may include additional data about each activity in the database. For example, the database may indicate the location of the activity and the time necessary to attend/perform the activity. The database may also include (or the media guidance application may determine (e.g., via processing circuitry 306 (FIG. 3)) the time necessary for the user, based on travel options of the user, to travel to/from the location. The media guidance application may compare the location and time information associated with the activity to the location of the first activity and remaining time availability of the user after the first activity.

If the media guidance application (e.g., via processing circuitry 306 (FIG. 3)) determines that the location exceeds a threshold distance from the first activity or that the time requirements of the second activity exceeds the remaining time availability of the user after the first activity, the media guidance application may determine that the second activity does not correspond to the second criteria. In contrast, if the media guidance application (e.g., via processing circuitry 306 (FIG. 3)) determines that the location does not exceed a threshold distance from the first activity or that the time requirements of the second activity do not exceed the remaining time availability of the user after the first activity, the media guidance application may determine that the second activity does correspond to the second criteria.

At step 518, in response to determining that the second activity corresponds to the second criteria, the media guidance application generates a display of the first activity and the second activity to the user. For example, in response to determining (e.g., via processing circuitry 306 (FIG. 3)) that a user may travel to the location of the second activity within his/her window of availability remaining from performance of the first activity, the media guidance application may determine that the second activity corresponds to the first activity and may generate a display (e.g., display 200 (FIG. 2A)) on a display screen (e.g., display 312 (FIG. 3)) of a user device (e.g., user equipment device 402, 404, and/or 406 (FIG. 4)).

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 5.

FIG. 6 is a flow-chart of illustrative steps involved in generating an itinerary of activities associated with media assets. It should be noted that process 600 or any step thereof, could be performed on, or provided by, any of the devices shown in FIGS. 3-4. For example, process 600 may be executed by control circuitry 304 (FIG. 3) as instructed by a media guidance application implemented on user equipment 402, 404, and/or 406 (FIG. 4) in order to produce a display (e.g., display 200 (FIG. 2A)) of activities associated with media guidance data (e.g., selected by a user via user input interface 310 (FIG. 3)). In addition, one or more steps of process 600 may be incorporated into or combined with one or more steps of any other process as described in FIGS. 5 and 7.

At step 602, the media guidance application receives a user selection of a media asset. For example, the media guidance application may detect (e.g., via processing circuitry 306 (FIG. 3)) a user request (e.g., via user input interface 310 (FIG. 3)) to view a particular media asset (e.g., program listing 108 (FIG. 1)).

At step 604, the media guidance application retrieves a window of availability and location information of a user. For example, the media guidance application may receive the window of availability of the user and the location of the user from one or more user inputs (e.g., received via user input interface 310 (FIG. 3)) selecting one or more selectable options (e.g., selectable options 202 (FIG. 2A)).

Alternatively or additionally, the media guidance may receive the window of availability of the user and the location of the user from a user profile. For example, the media guidance application may store information on one or more users in a user profile stored locally (e.g., on storage 308 (FIG. 3)) or remotely (e.g., at media guidance data source 418 and/or any location accessible via communications network 414 (FIG. 4)). For example, a user profile may include a current location of a user, content preferences of a user, and/or any other information used by the media guidance application to generate and/or select media assets for an itinerary.

At step 606, the media guidance application requests activities associated with the media asset. For example, the media guidance application may retrieve (e.g., via control circuitry 304 (FIG. 3)) a list of all activities associated with the media asset. The media guidance application may retrieve the list from a local (e.g. at storage 308 (FIG. 3) of user equipment device 402, 404, and/or 406 (FIG. 4)) and/or remote (e.g., at media content source 416 (FIG. 4) and/or any location accessible from communications network 414 (FIG. 4)) location.

At step 608, the media guidance application selects an activity from the available activities. For example, the media guidance application may determine (e.g., via processing circuitry 306 (FIG. 3)) there are multiple available activities. In order to associate (e.g., via processing circuitry 306 (FIG. 3)) an activity with the media asset, the media guidance application may select one of the available activities for processing.

At step 610, the media guidance application determines whether or not the activity corresponds to the window of availability of the user. For example, the media guidance application may cross-reference the media asset with a database associated with data about activities to retrieve information related to the length of time a particular activity requires to perform. For example, the media guidance application may input (e.g., using control circuitry 304 (FIG. 3)) an activity into the database (e.g., storage 308 (FIG. 3) or a storage device accessible via communications network 414 (FIG. 4)). The database (e.g., structured as a look-up table) may retrieve a field associated with the activity, in which a value or values indicative of the time required to perform an activity is contained. The media guidance application may then receive an output of the value or values in the field. The media guidance application may then determine (e.g., via processing circuitry 306 (FIG. 3)) if the value or values corresponds (e.g., has a sufficient amount of similarity) to the window of availability of a user.

If so, the media guidance application proceeds to step 612. If not, the media guidance application proceeds to step 616 and determines whether or not there are any additional available activities. At step 612, the media guidance application determines whether or not the activity corresponds to the location of the user. To determine the location of the user, the media guidance application (e.g., via processing circuitry 306 (FIG. 3)) may access one or more modules for receiving GPS data associated with a current position of the user. For example, the media guidance application cross-references the location of the user with a database associated with data about the locations of available activities to retrieve information related to the distance of the user to an activity. For example, the media guidance application may input (e.g., using control circuitry 304 (FIG. 3)) the activity into the database (e.g., storage 308 (FIG. 3) or a storage device accessible via communications network 414 (FIG. 4)). The database (e.g., structured as a look-up table) may retrieve a field associated with the activity, in which a value or values indicative of the location is contained. The media guidance application may then receive an output of the value or values in the field. The media guidance application may then determine if the value or values corresponds (e.g., if within a particular distance) to the user.

In some embodiments, the media guidance application may determine a distance between the user and an activity. The media guidance application may then determine a threshold distance that a user may travel. In some embodiments, the media guidance application may consider the available travel options, costs of various travel options, and/or any other user preferences when selecting a threshold distance. The media guidance application may then compare the distance between the user and the activity to the threshold distance. In response to determining that the threshold distance does not exceed the distance from the user to the activity, the media guidance application may determine that the activity corresponds to the location of the user.

If the media guidance application determines that the activity corresponds to the location, the media guidance application proceeds to step 614. If the media guidance application determines that the activity does not correspond to the location, the media guidance application proceeds to step 616 and determines whether or not there are any additional available activities. For example, if the media guidance application cannot locate a performance of a Broadway musical within a threshold radius of a user, the media guidance application may select a different activity associated with the media asset.

At step 614, the media guidance application stores the activity. For example, upon determining (e.g., via processing circuitry 306 (FIG. 3)) that an activity corresponds to both a window of availability of a user and a location of a user, the media guidance application may store (e.g., in storage 308 (FIG. 3)) the activity. At step 618, the media guidance application may determine whether or not there are any other available activities. If so, the media guidance application returns to step 608, if not, the media guidance application proceeds to step 618 and generates a list of stored activities.

For example, the media guidance application may generate (e.g., using control circuitry 304 (FIG. 3)) a list of all activities that at least correspond to the window of availability of the user and the location of the user. Additionally, the media guidance application may only list the activities that correspond to additional criteria (e.g., criteria associated with selectable options 202 (FIG. 2A) in a display (e.g., display 200 (FIG. 2A)) on a display screen (e.g., display 312 (FIG. 3)) on a user device (e.g., user equipment device 402, 404, and/or 406 (FIG. 4)).

At step 620, the media guidance application receives a user selection of one of the stored activities. For example, the media guidance application may detect (e.g., via processing circuitry 306 (FIG. 3)) a user request (e.g., via user input interface 310 (FIG. 3)) to add an activity to an itinerary (e.g., itinerary 252 (FIG. 2B)).

At step 622, the media guidance application requests activities associated with the selected activity. For example, the media guidance application may retrieve (e.g., via control circuitry 304 (FIG. 3)) a list of all activities associated with the selected activity. The media guidance application may retrieve the list from a local (e.g. at storage 308 (FIG. 3) of user equipment device 402, 404, and/or 406 (FIG. 4)) and/or remote (e.g., at media content source 416 (FIG. 4) and/or any location accessible from communications network 414 (FIG. 4)) location.

At step 624, the media guidance application selects an associated activity from the available activities. For example, the media guidance application may determine (e.g., via processing circuitry 306 (FIG. 3)) there are multiple activities associated with the selected activity. At step 626, the media guidance application determines whether or not the associated activity corresponds to the remaining window of availability of the user. For example, the media guidance application may cross-reference the associated activity with a database associated with data about activities to retrieve information related to the length of time the associated activity requires to perform.

For example, the media guidance application may input (e.g., using control circuitry 304 (FIG. 3)) the associated activity into the database (e.g., storage 308 (FIG. 3) or a storage device accessible via communications network 414 (FIG. 4)). The database (e.g., structured as a look-up table) may retrieve a field corresponding to the associated activity, in which a value or values indicative of the time required to perform the associated activity is contained. The media guidance application may then receive an output of the value or values in the field. The media guidance application may then determine (e.g., via processing circuitry 306 (FIG. 3)) if the amount of time necessary to perform the associated activity is less than or equal to a contiguous amount of time remaining in the window of availability of a user after perform the selected stored activity.

If so, the media guidance application proceeds to step 628. If not, the media guidance application proceeds to step 632 and determines whether or not there are additional activities associated with the selected activity. At step 628, the media guidance application determines whether or not the associated activity corresponds to the location of the selected activity. To determine the location of the associated activity and/or selected activity, the media guidance application (e.g., via processing circuitry 306 (FIG. 3)) may access one or more modules for receiving GPS data associated with the activity.

Additionally or alternatively, the media guidance application may cross-reference the associated activity and the selected activity in a database in order to determine the addresses of the associated activity and the selected activity. The media guidance application may then (e.g., via processing circuitry 306 (FIG. 3)) determine a distance from one address to the other. For example, the media guidance application may input (e.g., using control circuitry 304 (FIG. 3)) the associated activity and the selected activity into a database (e.g., storage 308 (FIG. 3) or a storage device accessible via communications network 414 (FIG. 4)). The database (e.g., structured as a look-up table) may retrieve a field corresponding to the associated activity, in which a value or values indicative of the address is contained. The database (e.g., structured as a look-up table) may also retrieve a field corresponding to the selected activity, in which a value or values indicative of the address is contained.

The media guidance application may then compare (e.g., via processing circuitry 306 (FIG. 3)) the address of the associated activity to the address of the selected activity. The media guidance application may then determine (e.g., via processing circuitry 306 (FIG. 3)) whether available travel options, costs of various travel options, and/or any other user preferences allow a user to travel from the associated activity to the selected activity or vice versa both within the amount of time remaining in the window of availability after subtracting the amount of time necessary to perform the selected activity and the associated activity.

If the media guidance application determines that the associated activity corresponds to the location of the selected activity, the media guidance application proceeds to step 630. If the media guidance application determines that the associated activity does not correspond to the location of the selected activity, the media guidance application proceeds to step 632 and determines whether or not there are additional associated activities. For example, if the media guidance application determines that a particular restaurant is too far from a Broadway musical a user is attending, the media guidance application may select a different restaurant.

At step 630, the media guidance application stores the associated activity. For example, upon determining (e.g., via processing circuitry 306 (FIG. 3)) that an activity corresponds to both a remaining window of availability and a location of a selected activity, the media guidance application may store (e.g., in storage 308 (FIG. 3)) the associated activity. At step 632, the media guidance application may determine whether or not there are any other available activities. If so, the media guidance application returns to step 624, if not, the media guidance application proceeds to step 632 and generates a list of the stored associated activities.

For example, the media guidance application may generate (e.g., using control circuitry 304 (FIG. 3)) a list of all activities that at least correspond to the remaining window of availability of the user and the location of the selected activity. For example, as shown in field 22 (FIG. 2B)), after a user selects an initial activity, the media guidance application may only list associated activities that correspond the distance to and time requirements.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

FIG. 7 is a flow-chart of illustrative steps involved in associating a media asset with an activity. It should be noted that process 700 or any step thereof, could be performed on, or provided by, any of the devices shown in FIGS. 3-4. For example, process 500 may be executed by control circuitry 304 (FIG. 3) as instructed by a media guidance application implemented on user equipment 402, 404, and/or 406 (FIG. 4) in order to produce a display (e.g., display 200 (FIG. 2A)) of activities associated with media guidance data (e.g., selected by a user via user input interface 310 (FIG. 3)). In addition, one or more steps of process 700 may be incorporated into or combined with one or more steps of any other process as described in FIGS. 5 and 6.

At step 702, the media guidance application generates an activities itinerary for a user. For example, in response a user selection and/or user action associated with media guidance data (e.g., as described in FIGS. 5-6 above), the media guidance application may determine one or more activities to generate for display (e.g., on display 312 (FIG. 3)) on a user device (e.g., user equipment device 402, 404, and/or 406 (FIG. 4)). The media guidance application may then include (e.g., via processing circuitry 306 (FIG. 3)) one or more activities in an activity itinerary in response to a user selection (e.g., via user input interface 310 (FIG. 3)) of the one or more activities.

At step 704, the media guidance application may retrieve a first activity from the activities itinerary. For example, the media guidance application may determine (e.g., via processing circuitry 306 (FIG. 3)) the activity itinerary has multiple activities. In order to associate (e.g., via processing circuitry 306 (FIG. 3)) media assets with each activity, the media guidance application may retrieve one of the activities. It should be noted that in some embodiments, process 700 may include multiple iterations. Alternatively or additionally, the media guidance application may perform (e.g., via processing circuitry 306 (FIG. 3)) one or more of the iterations (e.g., corresponding to one or more activities in the activity itinerary) simultaneously.

At step 706, the media guidance application retrieves all available media assets. For example, the media guidance application may retrieve (e.g., via control circuitry 304 (FIG. 3)) all available media assets available to a user from one or more devices. The media guidance application may retrieve media assets stored locally (e.g. at storage 308 (FIG. 3) of user equipment device 402, 404, and/or 406 (FIG. 4)) and/or media assets stored remotely (e.g., at media content source 416 (FIG. 4) and/or any location accessible from communications network 414 (FIG. 4)).

At step 708, the media guidance application may retrieve a media asset from the available media assets. For example, the media guidance application may determine (e.g., via processing circuitry 306 (FIG. 3)) there are multiple available media assets. In order to associate (e.g., via processing circuitry 306 (FIG. 3)) a media asset with the retrieved activity, the media guidance application may retrieve one of the available media assets. For example, a media guidance application may have access to television programs, movies, songs, etc. from multiple content providers (e.g., media content source 416 (FIG. 4)). The media guidance application may review all of the television programs, movies, songs, etc. from each content provider in order to determine whether or not any of the television programs, movies, songs, etc. corresponds to an activity in an activity itinerary of a user.

At step 710, the media guidance application determines whether or not the media asset corresponds to the subject matter of the activity. For example, the media guidance application cross-references the media asset with a database associated with data about the media asset to retrieve information related to the subject matter of the media asset. For example, the media guidance application may input (e.g., using control circuitry 304 (FIG. 3)) the media asset into the database (e.g., storage 308 (FIG. 3) or a storage device accessible via communications network 414 (FIG. 4)). The database (e.g., structured as a look-up table) may retrieve a field associated with the media asset, in which a value or values indicative of the subject matter of the media asset is contained. The media guidance application may then receive an output of the value or values in the field. The media guidance application may then determine if the value or values corresponds (e.g., has a sufficient amount of similarity) to the activity.

If so, the media guidance application proceeds to step 712. If not, the media guidance application returns to step 708 and retrieves a different media asset from the available media assets. For example, if an activity includes taking a bus to attend a Broadway musical, the media guidance application may recommend a media asset associated with the Broadway musical (e.g., trivia related to the cast and crew of the Broadway musical) for consumption by the user while the user is on the bus, whereas the media guidance application may not recommend a media asset not associated with the Broadway musical (e.g., news updates about stock market indices).

Additionally or alternatively, the media guidance application may retrieve information about the subject matter from data (e.g., metadata) transmitted with a media asset. For example, the media guidance application may select a media asset that includes a title, author, etc. associated with the activity. Furthermore, in some embodiments, the data transmitted with the media asset may include a specialized field that indicates the activity and/or subject matter of an activity that corresponds to the transmitted media asset.

Additionally or alternatively, the media guidance application may include and/or have access to one or more object recognition modules. An object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to identify subject matter of a media asset. For example, the media guidance application may receive a media asset in the form of a video (e.g., an audio/video recording of a user). The video may include a series of frames. For each frame of the video, the media guidance application may use an object recognition module to identify objects in the frame. In some embodiments, the content-recognition module or algorithm may also include audio analysis and speech recognition techniques, including, but not limited to, Hidden Markov Models, dynamic time warping, and/or neural networks (as described above) to process audio data and/or translate spoken words into text in order to identify objects.

In addition, the media guidance application may use multiple types of optical character recognition and/or fuzzy logic, for example, when analyzing subtitles (e.g., in order to determine the content of the media asset) or comparing multiple data fields (e.g., as contained in databases described herein). Using fuzzy logic, the system may determine two fields and/or values to be identical even though the substance of the data field or value (e.g., two different spellings) is not identical. In some embodiments, the system may analyze particular data fields of a database for particular values or text. Furthermore, the data fields could contain values (e.g., the data fields could be expressed in binary or any other suitable code or programming language) other than human-readable text.

At step 712, the media guidance application determines whether or not the media asset corresponds to the length of the activity. To determine the length of the media asset, the media guidance application (e.g., via processing circuitry 306 (FIG. 3)) may use any of the cross-referencing, data analysis, and/or object recognition methods discussed above. For example, the media guidance application cross-references the media asset with a database associated with data about the media asset to retrieve information related to the length of the media asset. For example, the media guidance application may input (e.g., using control circuitry 304 (FIG. 3)) the media asset into the database (e.g., storage 308 (FIG. 3) or a storage device accessible via communications network 414 (FIG. 4)). The database (e.g., structured as a look-up table) may retrieve a field associated with the media asset, in which a value or values indicative of the length of the media asset is contained. The media guidance application may then receive an output of the value or values in the field. The media guidance application may then determine if the value or values corresponds (e.g., has a sufficient amount of similarity) to the length of time associated with the activity.

If so, the media guidance application proceeds to step 714. If not, the media guidance application returns to step 708 and retrieves a different media asset from the available media assets. For example, if the activity of taking a bus to attend a Broadway musical is estimated to take twenty minutes, the media guidance application may recommend a media asset (e.g., for consumption by the user while the user is on the bus) that has a runtime of twenty minutes. Additionally or alternatively, the media guidance application may recommend a cropped media asset (e.g., cropped to a runtime of twenty minutes) or multiple media assets (e.g., with a sum of runtimes equal to twenty minutes).

At step 714, the media guidance application associates the media asset with the activity. For example, the media guidance application may populate (e.g., via processing circuitry 306 (FIG. 3)) an activity itinerary (e.g., itinerary 252 (FIG. 2B)) on a display screen (e.g., display 312 (FIG. 3) of user equipment device 402, 404, and/or 406 (FIG. 4)). The media guidance application may thereafter present the media asset at the scheduled time. Additionally or alternatively, the media guidance application (e.g., via control circuitry 304 (FIG. 3)) may receive one or more user inputs (e.g., via user input interface 310 (FIG. 3)) modifying the media asset and/or corresponding activity.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for recommending an activity associated with media assets, the method comprising:
receiving a user selection of a media guidance datum;
cross-referencing the selected media guidance datum with a database associated with activities associated with media guidance data to retrieve a first activity associated with the selected media guidance data;
retrieving first criteria from memory, wherein the first criteria indicates a location of a user and a window of availability of the user;
determining whether the first activity corresponds to the first criteria;
in response to determining the first activity corresponds to the first criteria, selecting the first activity;
identifying a second activity associated with the first activity;
retrieving second criteria from the memory, wherein the second criteria indicates a location associated with the first activity and an amount of the window of availability not consumed by the first activity;
determining whether the second activity corresponds to the second criteria; and
in response to determining the second activity corresponds to the second criteria, generating a display of the first activity and the second activity to the user.

2. The method of claim 1, further comprising:
selecting a first media asset associated with the first activity for presentation during the first activity; and
selecting a second media asset associated with the second activity for presentation during the second activity.

3. The method of claim 1, wherein the first activity and the second activity require a user to move to a different geographic location.

4. The method of claim 1, further comprising generating a display of an itinerary including the first activity and the second activity.

5. The method of claim 4, further comprising generating a display of an option to modify the first activity or the second activity in the itinerary.

6. The method of claim 4, further comprising:
in response to receiving a user input requesting to change the second activity, determining a third activity associated with the first activity;
determining whether the third activity corresponds to the second criteria; and
in response to determining the third activity corresponds to the second criteria, generating a display of the first activity and the third activity to the user.

7. The method of claim 1, wherein the window of availability indicates a length of time available to the user to perform activities.

8. The method of claim 1, wherein the window of availability indicates a start time and an end time available to a user.

9. The method of claim 1, further comprising:
determining a location of the first activity;
comparing the location of the first activity to the location of the user;
based on the comparison, determining whether the user can reach the location of the first activity within the first time period.

10. The method of claim 9, wherein determining whether the user can reach the location of the first activity within the first time period, further comprises:
determining a travel option available to the user; and
determining a transit time associated with the travel option.

11. A system for recommending an activity associated with media assets, the system comprising control circuitry configured to:
receive a user selection of a media guidance datum;
cross-reference the selected media guidance datum with a database associated with activities associated with media guidance data to retrieve a first activity associated with the selected media guidance data;
retrieve first criteria from memory, wherein the first criteria indicates a location of a user and a window of availability of the user;
determine whether the first activity corresponds to the first criteria;
in response to determining the first activity corresponds to the first criteria, select the first activity;
identify a second activity associated with the first activity;
retrieve second criteria from the memory, wherein the second criteria indicates a location associated with the first activity and an amount of the window of availability not consumed by the first activity;
determine whether the second activity corresponds to the second criteria; and
in response to determining the second activity corresponds to the second criteria, generate a display of the first activity and the second activity to the user.

12. The system of claim 11, wherein the control circuitry is further configured to:
select a first media asset associated with the first activity for presentation during the first activity; and
select a second media asset associated with the second activity for presentation during the second activity.

13. The system of claim 11, wherein the first activity and the second activity require a user to move to a different geographic location.

14. The system of claim 11, wherein the control circuitry is further configured to generate a display of an itinerary including the first activity and the second activity.

15. The system of claim 14, wherein the control circuitry is further configured to generate a display of an option to modify the first activity or the second activity in the itinerary.

16. The system of claim 14, wherein the control circuitry is further configured to:
in response to receiving a user input requesting to change the second activity, determine a third activity associated with the first activity;
determine whether the third activity corresponds to the second criteria; and
in response to determining the third activity corresponds to the second criteria, generate a display of the first activity and the third activity to the user.

17. The system of claim 11, wherein the window of availability indicates a length of time available to the user to perform activities.

18. The system of claim 11, wherein the window of availability indicates a start time and an end time available to a user.

19. The system of claim 11, wherein the control circuitry is further configured to:
determine a location of the first activity;
compare the location of the first activity to the location of the user;
based on the comparison, determine whether the user can reach the location of the first activity within the first time period.

20. The system of claim 19, wherein the control circuitry configured to determine whether the user can reach the location of the first activity within the first time period, is further configured to:
determine a travel option available to the user; and
determine a transit time associated with the travel option.

21-40. (canceled)
